(19) United States
(12) Patent Application Publication
(10) Pub. No.: US 2011/0171367 A1
(43) Pub. Date: Jul. 14, 2011

(54) METHOD FOR IMPROVING THE CORROSION RESISTANCE OF AN ELECTRONIC COMPONENT, PARTICULARLY OF CONDUCTORS OF A PRINTED CIRCUIT BOARD

(76) Inventor: Hannes Voraberger, Graz (AT)

(21) Appl. No.: 13/120,017

(22) PCT Filed: Sep. 22, 2009
(86) PCT No.: PCT/AT2009/000367

§ 371 Date: Mar. 21, 2011

(30) Foreign Application Priority Data
Sep. 24, 2008 (AT) GM 524/2008

(51) Int. Cl. B05D 5/00; B05D 3/10

(52) U.S. Cl. 427/96.2

(57) ABSTRACT

In a method for improving the corrosion resistance of an electronic component, particularly of conductors of a printed circuit board, wherein after the conductors are produced out of copper a further treatment follows, the conductors are subjected to a pretreatment prior to the further treatment, wherein ions or ion impurities present on the surface of the conductors are removed by a purifying treatment and/or treated with at least one complexing composition, whereby the production of conductors and/or printed circuit boards having improved corrosion resistance, particularly when used in surroundings having higher moisture and optionally higher temperatures, becomes possible.

This is a national stage of PCT/AT2009/000367 filed Sep. 22, 2009 and published in German, which has a priority of Austria no. GM 524/2008 filed Sep. 24, 2008, hereby incorporated by reference.

### FIELD OF THE INVENTION

The present invention relates to a method for improving the corrosion resistance of an electronic component, particularly of conductors of a printed circuit board, wherein after the conductors are produced out of copper, a further treatment follows.

### PRIOR ART

Further treatments following the formation of conductor tracks in the context of the production of a printed circuit board may, for instance, comprise the application and hardening of a solder mask for preparing and applying further layers or elements or for structuring a printed circuit board layer, or the arrangement or formation of further or additional printed circuit board layers. Particularly with the further increasing reduction of the dimensions of such printed circuit board layers, especially their thicknesses, and optionally also a further reduction of the dimensions and mutual distances of conductor tracks, the problems pointed out below may also occur between conductor tracks of individual superimposed printed circuit board layers, in particular when used under conditions of moisture and elevated temperatures.

In the context of the production of printed circuit boards and prior to the use of such printed circuit boards, it is known to subject printed circuit boards to numerous tests, wherein, in particular, printed circuit boards that are to be used under moist conditions and, if required, under conditions comprising temperatures elevated relative to ambient temperature are subjected to a so-called HAST (High Accelerated Stress Test). In such a test, printed circuit boards to be examined, for instance, have to withstand a resistance of more than 10 Mohm for at least 264 hours at an ambient temperature of 110° C. and a relative humidity of 85% under a pressure slightly higher than ambient pressure, for instance 1.2 bar. It has been shown that under such test conditions and, in general, during use under conditions of high moisture and elevated temperature a plurality of printed circuit boards produced by conventional production methods are subject to corrosion influences, particularly after the formation of conductor tracks comprised of copper, which, due to the increasingly complex structures of printed circuit boards, for instance, have reduced thicknesses and hence, in particular, accordingly reduced mutual distances of less than 50 micrometers, and, for instance, the subsequent application of a solder mask or application of a further printed circuit board layer for the contacting of printed circuit board portions to be effected after this. This is why such printed circuit boards will subsequently fail, particularly when used in surroundings of elevated moisture and possibly also elevated temperature, which are, for instance, encountered in the above-mentioned test and which are to simulate a checkup for long-term use under such conditions of elevated moisture and possibly elevated temperature.

Such a failure, which is accompanied by the formation of short-circuits or the like, prior to the expiration of the above-indicated minimum test period or during the use of such printed circuit boards under the above-identified unfavorable conditions is, in particular, attributable to the formation of copper dendrites and hence a conductivity based on electrons, or the formation of copper filaments and hence a conductivity based on ions, between the conductor tracks comprising, in particular, slight mutual distances between each other. There are, however, no proposed solutions for avoiding these known phenomena or mechanisms, which have been known and described for quite some time and which, at increasingly smaller conductor distances and possibly smaller conductor thicknesses, have led to major portions of products that do not pass such checks or tests and thus have to be rejected.

### SUMMARY OF THE INVENTION

The present invention, therefore, aims to provide a method of the initially defined kind, by which it is feasible to improve the corrosion resistance of an electronic component, particularly of conductor tracks of a printed circuit board, to the effect that the options of use of such printed circuit boards will be improved, particularly in high-moisture environments, and the options to successfully complete or pass such tests like HAST will be increased while reducing the portion of rejects.

To solve these objects, the method of the initially defined kind is essentially characterized in that the conductors are subjected to a pretreatment prior to further treatment, wherein ions and/or ion impurities present on the surface of the conductors are removed by a purifying treatment and/or treated with at least one complexing composition. In that, as in correspondence with the invention, a pretreatment is provided for the conductors or conductor tracks prior to further treatment and, in particular, prior to the application of a solder mask or the formation of a further printed circuit board layer, in which pretreatment ions or ion impurities present on the surfaces of the conductor tracks are removed by a purifying treatment or the conductor tracks are treated with at least one complexing composition, it has become possible to provide on the surfaces of the conductor tracks, after this treatment or pretreatment, substantially metallic copper or copper complexes, whose presence will, in particular, avoid, or largely reduce, the formation of copper oxide in subsequent processing steps, for instance during or after the application of a solder mask, and at elevated temperatures as are applied for the hardening of a solder mask. When using such a printed circuit board under conditions of high temperature and high moisture, for instance during the execution of and examination by HAST, such copper oxide would subsequently form or provide a microenvironment that would promote the above-mentioned mechanisms of the formation or growth of copper filaments and/or copper dendrites, so that such conductors or printed circuit boards including such conductors will not meet the respective requirements in further consequence. By the purifying treatment provided according to the invention, copper ions and/or ion impurities on the surfaces of the conductors will be largely removed such that, for instance during a subsequent treatment or processing step, the formation of, in particular, copper oxide will be largely prevented or avoided because of the major lack of copper ions such that, in further consequence, the favorable conditions required for the above-mentioned phenomena or mechanisms of the formation of copper dendrites or copper filaments will not or no longer be provided. In a similar manner, it has become possible by treatment with a complexing composition to likewise strongly reduce or minimize the number of copper ions present on the surface of a conductor track so as to likewise avoid, in further consequence, particularly during use in surroundings of high relative humidity, the problems involved in the growth of copper dendrites or copper filaments and enable the successful completion of the respective checks or tests. Moreover, it is to be anticipated that even free copper ions possibly provided or present in the vicinity of conductor tracks, particularly on a dielectric, will be removed by the proposed treatment with an ion-removing cleaning solution and/or with at least one complexing composition, so that even such free copper ions originally present, for instance, on the surface of a dielectric will subsequently no longer be able to provide the favorable conditions for the formation of copper dendrites or copper filaments, particularly in regions of small mutual distances between adjacent conductor tracks.

It is thus possible, by providing a simple purifying step and/or a treatment with a complexing composition prior to further processing, to make available a copper conductor track surface substantially comprising metallic copper or copper complexes and, in any event, a strongly reduced number of free copper ions and/or ion impurities such that there will no longer be a basis for the formation of copper oxide in subsequent treatment steps and, in particular, in a subsequent treatment at elevated temperature. Such a pretreatment step can, for instance, be combined with, or largely substitute for, known purifying steps, so that existing printed circuit board production plants, in particular, need not be modified for achieving said improved corrosion resistances, but only materials or substances especially used for purifying treatments will be partially replaced or supplemented.

In order to achieve the proper and reliable removal of free ions and/or ion impurities present on the surfaces of conductor tracks, it is proposed according to a preferred embodiment of the method according to the invention that the purifying treatment is performed with at least one reducing or etching composition. Such a reducing or etching composition allows for the reliable removal of free ions and possible ion impurities such as, e.g. copper hydroxide, on the surfaces of conductor tracks and optionally in the vicinity of such conductor tracks, on a dielectric, wherein, in this context, it is proposed according to a further preferred embodiment of the method according to the invention that sulfuric acid is used for the purifying treatment. To achieve the desired purifying effect by removing the surfaces of conductor tracks, and considering the conductor tracks usually having small thicknesses and/or heights, it is additionally proposed in this respect that sulfuric acid is used at a maximum concentration of 35%.

To further improve the purifying treatment or removal effect of the ions and/or ion impurities present on the surfaces of conductor tracks, while optionally taking into account materials used in preceding processing steps, which, if required, are to be removed simultaneously with the removal of the free ions, it is proposed according to a further preferred embodiment that a mixture of sulfuric acid and an additional reducing agent selected from the group consisting of hydrogen peroxide, formic acid, hydro-chloric acid, phenolsulfonic acid or the like is used for the purifying treatment. Such additional reducing and/or etching agents are at least partially known for the processing or treatment of printed circuit boards such that, as already pointed out above, the method according to the invention can also be used for existing printed circuit board production plants to, for instance, replace or supplement purifying steps that are to be provided.

In the context of the formation of copper complexes, it is proposed according to a further preferred embodiment that ammonia is used as a complexing composition. The formation of such copper complexes will again ensure that free copper ions and/or ion impurities present on the surface will be removed or replaced particularly by the formation of very stable complexes such that, as already pointed out above, the prerequisites for the formation of, in particular, copper oxide will again be deteriorated in the context of further treatment steps. As a result, the prerequisites for the formation or growth of copper dendrites or copper filaments will subsequently be reduced or minimized, particularly when introducing or using such a printed circuit board produced by the method according to the invention in high-moisture environments, and the quality of the produced printed circuit boards will thus be strongly improved.

Instead of the formation of copper complexes by using ammonia, organic copper complexes can, in particular, also be formed on the surfaces of conductor tracks, wherein, in this context, it is proposed according to a further preferred embodiment that at least one organic complexing composition such as, for instance, EDTA, potassium hydrogen tartrate, ethylenediamine, nitrilotriacetic acid and the like is used.

For the particularly simple realization of the method according to the invention, it is proposed that the purifying treatment and/or the treatment with a complexing composition is performed in a spraying method, as in correspondence with a preferred further development of the method according to the invention.

In order to achieve the desired purification or formation of a complexing layer, it is proposed according to a further preferred embodiment that the purifying treatment and/or the treatment with a complexing composition is performed at a temperature below 50° C., in particular below 40° C., and for a period of at least 1 s, in particular at least 10 s, so that short-term treatments at comparatively low temperatures will do.

As already pointed out above, it is possible by a purifying treatment for removing free ions or ion impurities present on the surface and/or by forming complexes, to provide above all a conductor surface structure that strongly reduces or minimizes the formation of, in particular, copper oxide in further treatment steps, particularly at elevated temperatures. To further improve the surface properties with a view to preventing the formation of such copper oxides on the surface, this consequently preventing or at least strongly reducing the formation of copper dendrites or copper filaments, it is proposed according to a further preferred embodiment of the method according to the invention that a protective layer is applied on the conductors after having carried out the purifying treatment and/or treatment with at least one complexing composition. After having provided a substantially metallic conductor surface or a conductor surface comprising highly stable complexes, it is thus feasible to provide additional sealing of the surface of a conductor track relative to the formation of, in particular, copper oxide so as to further improve the reduction or avoidance of the formation of copper dendrites or copper filaments when using such printed circuit boards in high-moisture environments. In this context, it is, moreover, proposed that an organic preservative, in particular an organic copper surface preservative, is applied as a protective coating to preserve the solderability, as in correspondence with a further preferred embodiment of the method according to the invention.

To further minimize the formation of copper dendrites or copper filaments during the subsequent use of a completed circuit board in high-moisture environments, it is proposed according to a further preferred embodiment that the further treatment is carried out after a period of at most hours, in particular at most 10 hours, following the implementation of the purifying treatment and/or the treatment with at least one complexing composition and/or the application of a protective layer. By observing the maximum period of 48 hours proposed by the invention after the implementation of the purifying treatment and/or the treatment with at least one complexing composition and/or the application of a protective layer, it will be ensured that the desired favorable properties of providing a metallic surface, or surface with stable complexes, which is optionally protected by the application of a protective layer, will be maintained during subsequent treatment steps. When exceeding the indicated time prior to further processing, a new purifying treatment and/or treatment with at least one complexing composition should be advantageously be performed, albeit over an optionally reduced period, in order to subsequently maintain or provide the desired favorable properties for preventing the growth of copper dendrites or copper filaments.

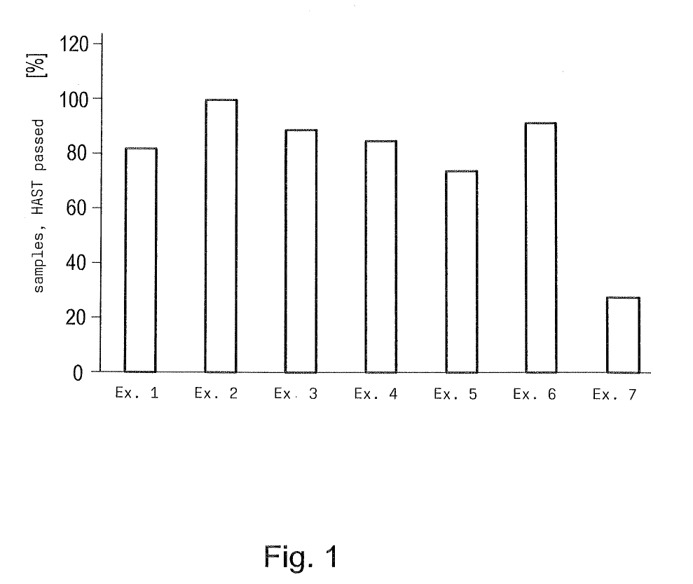

In the following, the invention will be explained in more detail by way of exemplary embodiments of the method according to the invention. In addition, FIG. 1 shows a diagram from which the improvements to be achieved by a treatment using the method according to the invention, to successfully pass a HAST as compared to a conventional treatment of a printed circuit board are apparent.

To begin with, the mechanism according to which, in known production methods with the subsequent use of a printed circuit board in high-moisture environments and, for instance, during the performance of a HAST at a temperature of 110° C. and a relative humidity of 85%, the growth of copper dendrites or copper filaments leads to a failure of such a printed circuit board due to short-circuits should be briefly explained.

After the production of conductor tracks of a printed circuit board of copper, which, for instance, comprise small widths and accordingly small mutual distances of, e.g., less than 50 micrometers, there will be free copper ions or Cu(OH)₂ on the surfaces of the conductor tracks, or in the immediate vicinity on the surface of a dielectric surrounding a conductor track, after photostripping with, for instance, NaOH. During subsequent processing steps, for instance precleaning prior to applying a solder mask and subsequent hardening of the solder mask at temperature of usually more than 80° C., copper hydroxide will react to copper oxide, said copper oxide being much more harder to dissolve and remove from the surface than copper hydroxide.

If such copper oxide, after the production of the conductor tracks and printed circuit boards comprising the conductor tracks, are subsequently exposed to a high-moisture environment and, possibly, high temperatures, as happens for instance during a check by HAST, such copper oxide will be able to provide or form a microenvironment that will promote the growth or formation of copper filaments and/or copper dendrites. Such copper filaments and/or copper dendrites will subsequently lead to short-circuits between conductor tracks comprising accordingly small mutual distances, and hence to an overall failure of such printed circuit boards, during those tests or, in general, when used under high-moisture conditions.

By contrast, the method according to the invention, prior to further processing under, in particular, elevated temperature and, in particular, prior to the application of a solder mask or the application of a further printed circuit board layer and the subsequent hardening of the solder mask, provides for a pretreatment that enables free copper ions or, if necessary, ions from impurities, such as, e.g., already formed copper hydroxide, to be removed from the surfaces of conductor tracks and, if necessary, also from the near vicinity of conductor tracks, from a dielectric. It will thus, moreover, be possible prior to subsequent treatment steps and, in particular, the exposure to elevated temperatures and elevated moisture, to prevent or largely reduce the formation of, in particular, copper oxide, which, as pointed out above, will in turn provide favorable conditions for the growth of copper dendrites or copper filaments and hence lead to the subsequent failure of such a printed circuit board, particularly when used in high-moisture environments.

### SHORT DESCRIPTION OF THE DRAWINGS

In order to prevent such a formation of, in particular, copper oxide in subsequent treatment steps, three groups of treatment processes will be discussed in detail below, which, when used separately, will each provide an already strong improvement in terms of corrosion resistance enhancement of an electronic component and, in particular, conductor tracks of a printed circuit board, as can also be taken from the diagram illustrated in FIG. 1, which will be discussed in detail below. With the cumulative application of at least two of the process controls indicated below, the achievable results with regard to an improvement of the corrosion resistance will be accordingly enhanced.

### DETAILED DESCRIPTION OF PREFERRED EMBODIMENTS

### 1. Cleaning Treatment Using a Reducing or Etching Composition

Instead of cleaning a conductor track with water or acid or etching solutions of low concentration, as is the case with known methods, the use of, for instance, the following cleaning or etching solutions for providing conductor track surfaces that are free of copper ions or copper ion impurities like copper hydroxide and thus substantially provide metallic copper is proposed. For the cleaning solutions mentioned below, it is to be anticipated that the used acids are present in concentrated form.

The following solutions are proposed as cleaning or etching solutions, with additional parameters being, moreover, indicated for each solution regarding temperature, treatment time, type of application etc.

a) Purifying Solution 1

H₂SO₄: 5.5%

HCl: 5.5%

Balance: H₂O

The purifying solution is used in a spraying method, with the treatment being effected at a temperature of 25° C. and for a period of 30 s.

b) Purifying Solution 2

H₂SO₄: 2%

HCl: 2%

Balance: H₂O

The purifying solution is used in a spraying method, with the treatment being effected at a temperature of 30° C. and for a period of 60 s.

c) Purifying Solution 3

H₂SO₄: 2.5%

HCl. 1%

Formic acid: 1%

Balance: H₂O

The purifying solution is used in a spraying method, with the treatment being effected at a temperature of 40° C. and for a period of 20 s.

d) Purifying Solution 4

H₂SO₄: 4%

HCl: 1%

Formic acid: 1.5%

Balance: H₂O

The purifying solution is used in a spraying method, with the treatment being effected at a temperature of 40° C. and for a period of 30 s.

e) Purifying Solution 5

Potassium monopersulfate: 1%

H₂SO₄: 2.5%

Balance: H₂O

The purifying solution is used in a spraying method, with the treatment being effected at a temperature of 32° C. and for a period of 30 s.

It is thus possible to work with solutions having only low acid concentrations or portions and providing the desired purification effects at comparatively low temperatures and short treatment times. To further shorten the treatment time and, if desired, accelerate the method, accordingly higher acid concentrations or portions could be used.

After such a treatment with a purifying or etching solution or composition containing at least sulfuric acid, a metallic conductor surface substantially free of copper ions or ion impurities as well as a surface free of copper ions or impurities of an adjacent dielectric will be provided.

Following a subsequent treatment step, particularly at elevated temperature, for instance the application of a solder mask and hardening at elevated temperatures, e.g. more than 80° C., or the application of an additional or further circuit board layer, no copper oxide formation will occur on the surface due to the absence of free copper ions and, in particular, copper hydroxide so that, when completing such a conductor track or printed circuit boards provided with such conductor tracks, the growth of copper dendrites or copper filaments usually resulting in a failure of such a printed circuit board because of the formation of short-circuits between slightly spaced-apart conductor tracks will subsequently be largely reduced or completely avoided, even when using the same in environments of elevated moisture and, possibly, elevated temperature.

### 2) Complexing of Copper Ions

a) Treatment of the surfaces of conductors tracks with ammonia (e.g. 0.5%) for forming stable complexes, e.g. Cu (NH₃)+.

In doing so, an aqueous ammonia solution having a pH of between 8.7 and 9.7 is used, the adjustment of the pH being effected with concentrated NH₃. Complexing is performed by a spraying method at 25° for 30 s.

b) Formation of other copper complexes such as, e.g. Cu(CN)²⁻

c) Formation of organic complexes

d) Use of at least about 1% solutions of EDTA, potassium hydrogen tartrate, ethylenediamine, nitrilotriacetic acid or the like

For treatment with potassium hydrogen tartrate, a 1% solution is used at a treatment temperature of 25° C., with the treatment being carried out in a spraying method for 30 s.

By forming such stable complexes, it will subsequently be prevented, like with the formation or provision of metallic copper in a purifying treatment using one of the purifying solution proposed in group 1, that, for instance, by the formation of copper oxide when used in high-moisture and high-temperature environments the formation of copper dendrites or copper filaments does occur, which will consequently lead to failures of such printed circuit boards due to short-circuits.

### 3. Formation or Application of a Protective Layer

In the context of the application of a protective layer for protecting conductor tracks and, in particular, preventing copper oxide, it is, for instance, known to perform, particularly in a two-step method, a pretreatment or precoating of a conductor surface comprised of copper in a first method step, whereupon a protective layer of an organic preservative, in particular an organic copper surface preservative, is applied in a second method step to preserve solderability. By applying an organic protective layer, said pretreatment imparts selectivity to the copper conductor track as to the preservative to be additionally applied after this, wherein it has been shown that the desired increase in the corrosion resistance will already be achieved by merely performing the pretreatment of applying an organic precoat, as will be discussed in detail by way of the diagram illustrated in FIG. 1.

Such a protective layer will likewise not only prevent the formation of copper oxide, but also be usable to adjust the pH of the method or processing steps to follow.

At present, the formation or application of such protective layers is, for instance, known in the context of preserving the solderability of conductor tracks, wherein methods of this type and, in particular, two-step methods are employed or used.

Moreover, the use of such a formation or application of a protective layer, or at least a precoat, in the context of such a two-step method known per se enables, for instance, a change of the pH in the microenvironment next to the surface of a produced conductor track, a change in the ionic strength etc. in order to subsequently provide favorable conditions for increasing the corrosion resistance, as was proved by a plurality of checks, which further led to additional improvements of the corrosion resistance as illustrated in FIG. 1. Currently known methods for forming a protective layer, which are particularly aimed to preserve or enhance solderability, in an at least partially surprising manner can thus also be used to adjust or influence further parameters improving the further processability and use of a printed circuit board produced or processed in this manner and, in particular, its corrosion resistance in moist environments.

The diagram depicted in FIG. 1 shows for various exemplary embodiments of the treatment of conductor tracks of a printed circuit board by the subsequently indicated treatment steps, each in a bar graph, the percentages at which printed circuit boards to be tested according to the examples after the treatments listed below have passed the HAST.

The following treatments after the formation of copper conductor tracks and optionally subsequent processing steps were carried out for the individual examples illustrated in FIG. 1. The indicated purifying solutions or complexing operations and the formation of a protective layer each refer to the respective process controls and solutions described above under points 1, 2 and 3.

### EXAMPLE 1

Purifying solution 4

### EXAMPLE 2

Purifying solution 4+purifying solution 5+complexing 2a+organic protective layer (precoating according to point 3, precoat)

### EXAMPLE 3

Purifying solution 1+purifying solution 2+complexing 2a+organic protective layer (precoat according to point 3)

### EXAMPLE 4

Purifying solution 5+complexing 2a

### EXAMPLE 5

Purifying solution 1+purifying solution 2

### EXAMPLE 6

Purifying solution 4+purifying solution 5+complexing 2a+organic protective layer (precoat according to point 3)+organic protective layer according to point 3

### EXAMPLE 7

Conventional treatment of a printed circuit board after the formation of a conductor track without any solution or method step of at least one of groups 1 to 3 as indicated in detail above.

From the illustration according to FIG. 1 it is apparent that, when using at least one method step according to the invention, a strong improvement of the percentage of successfully tested samples when using the HAST will be achieved.

It has in fact been shown that, when using conventional method conditions as according to Example 7, about 25% of the samples pass the HAST, while already the application of just one treatment using at least one purifying solution brings about an improvement to at least 75%, as can be taken from Examples 1 and 5.

When additionally providing a complexing step according to Example 4, the percentage of samples that pass the HAST can be increased to 85%.

Further improvements will be achieved by additionally providing at least one organic protective layer in the form of a precoat and an additional organic layer according to the two-step method mentioned under point 3, wherein a comparison of Examples 2, 3 and 6 reveals that the best result, in Example 2, will only be achieved when using an organic protective layer as a precoat, whereby a percentage of 100% successful samples was achieved.

In respect to the percentages represented in FIG. 1, it is, moreover, noted that a check by HAST was each performed on a plurality of samples treated according to Examples 1 to 7, at least 50 samples having been subjected to checks in order to determine the percentage for each exemplary embodiment according to the exemplary embodiments 1 to 6 and 35 samples having been examined for Example 7.

It is thus clearly apparent from FIG. 1 that a considerable increase in the corrosion resistance of electronic components and, in particular, conductor tracks of a printed circuit board will already be achieved by providing or using a pretreatment in the form of a purifying treatment for removing ions or ion impurities present on the surfaces of conductor tracks, as is, for instance, examined by a standardized HAST.

It is, moreover, apparent that the additional execution of a complexing step and optionally the formation of an organic protective layer in the form of a precoat will provide further improvements of the corrosion resistance, as can be taken from a further enhancement of, or increase in, the percentage of samples that are successful in the HAST, whereby, in particular, the use of a combination of purifying solutions and a complexing step for forming an organic protective layer in the sense of a precoat makes all samples pass the HAST.

For a continued treatment following the implementation of at least one of the methods set out under points 1) to 3) in order to avoid environmental influences during the storage of the conductor tracks, it is intended to carry out a further treatment after a maximum period of 48 hours and, even more advantageously, 10 hours.

If such a period is exceeded prior to that further treatment, the respective process control according to at least one of points 1) to 3) should at least be repeated within a shortened period of time in order to avoid the formation of copper oxide during subsequent method steps.

1-11. (canceled)

12. A method for improving the corrosion resistance of an electronic component, particularly of conductors of a printed circuit board, wherein after the conductors are produced out of copper, these are subjected to a pretreatment prior to the further treatment, wherein ions and/or ion impurities present on the surface of the conductors are removed by a purifying treatment, wherein after the purifying treatment the conductors are treated with at least one complexing composition.

13. The method according to claim 12, wherein the purifying treatment is performed with at least one reducing or etching composition.

14. The method according to claim 12, wherein sulfuric acid is used for the purifying treatment.

15. The method according to claim 14, wherein a mixture of sulfuric acid and an additional reducing agent selected from the group consisting of hydrogen peroxide, formic acid, hydrochloric acid, phenolsulfonic acid or the like is used for the purifying treatment.

16. The method according to claim 12, wherein ammonia is used as a complexing composition.

17. The method according to claim 12, wherein at least one organic complexing composition such as, for instance, EDTA, potassium hydrogen tartrate, ethylenediamine, nitrilotriacetic acid and the like is used.

18. The method according to claim 12, wherein the purifying treatment and/or the treatment with a complexing composition is performed in a spraying method.

19. The method according to claim 12, wherein the purifying treatment and the treatment with a complexing composition is performed at a temperature below 50° C., in particular below 40° C., and for a period of at least 1 s, in particular at least 10 s.

20. The method according to claim 12, wherein a protective layer is applied on the conductors after having carried out the purifying treatment and/or treatment with at least one complexing composition.

21. The method according to claim 20, wherein an organic preservative, in particular an organic copper surface preservative, is applied as a protective layer to preserve the solderability.

22. The method according to claim 12, wherein the further treatment is carried out after a period of at most 48 hours, in particular at most 10 hours, following the implementation of the purifying treatment and/or the treatment with at least one complexing composition and/or the application of a protective layer.
